(19) United States
(12) Patent Application Publication
(10) Pub. No.: US 2006/0000558 A1
(43) Pub. Date: Jan. 5, 2006

(54) Solar-Powered, Low-Voltage, Automatic, Motorized Exterior Window Shading Device

(75) Inventor: James R. Fennell, Colorado Springs, CO (US)

Correspondence Address: James Fennell, 20 West Washington, Colorado Springs, CO, 80907, US

(73) Assignee: James Fennell, Colorado Springs, CO (US)

(21) Appl. No.: 11/162,524

(22) Filed: Sep. 13, 2005

(51) Int. Cl. E05F 15/20

(52) U.S. Cl. 160/7

(57) ABSTRACT

An exterior-mounted motorized window shade system that is solar powered and automated using a microcontroller that evaluates environmental sensor input for predefined thresholds regarding direct sunlight, temperature, moisture, and wind speed and then actuates the extension or retraction direction of the motor based on that input.

### BACKGROUND OF THE INVENTION

1. Field of the Invention

The present invention relates to exterior-mounted motorized window shade systems. More specifically, to a window shade system that is operated by a low-voltage solar-powered reversible DC motor. Furthermore, the invention relates to a solar-powered motorized window shade system that incorporates automated functions whereby the motor is actuated for up or down motion based on sensor input for predefined thresholds regarding direct sunlight, temperature, moisture, and wind speed.

2. Description of Related Art

Window shades are used to control room temperature and light. Most window shades are mounted inside the building, still allowing ultraviolet radiation to pass through the glass and raise the temperature of the building. Exterior mounted window shades address the issue by interrupting the flow of radiation before it crosses the glass barrier.

The improvements of window shades have included the application of electric motors, as in U.S. Pat. Nos. 5,467,266, 5,848,634, 6,100,659, 6,201,364, and 6,708,750 that allows users to move the shade up or down by flipping a switch or using a remote control device.

This improvement requires an external power source for each shade. Adding external power supplies to existing buildings is often beyond the skills of the homeowners and can be prohibitively expensive to have installed by professional electricians.

Further enhancements have included the application of solar power for running the motor, as in U.S. Pat. Nos. 5,040,585, 5,029,428, and 5,413,161. But the control of the window shades still retains the need for human intervention. There are some exceptions. Some inventions have added timer devices, for example, U.S. Pat. Nos. 4,173,721 and 5,413,161, and at least one invention has a thermal sensor, U.S. Pat. No. 4,255,899.

However, no exterior mounted, solar-powered window shade is automated for extension and retraction based on sensitivity to four criteria: the presence of full sunlight, outside temperature, presence of moisture, and acceptable wind conditions.

This invention provides an easy to install solar-powered exterior window shade that is automated, based on predefined environmental conditions, for extension and retraction.

### SUMMARY OF THE INVENTION

The object of the invention is to provide a motorized exterior-mounted window shade system that is simple to install and requires no external power source.

The further object is that the motor be solar powered.

It is also a further object of the invention that it be automated where the automatic extension and retraction of the shade is based on combined thresholds for direct sunlight, temperature, moisture level, and wind speed through the use of a microprocessor. The invention, by being sensitive to environmental input, can then take the specified action, to extend or retract the shade, without user initiation.

It is also the object of the invention to be externally mounted and simple to install. The solar-powered motor eliminates the need for an external power source.

This invention is a solar-powered, automatic exterior window shade that extends and retracts based on set thresholds of sunlight, temperature, moisture, and wind speed.

### BRIEF DESCRIPTION OF DRAWINGS

FIG. 1 is a sectional view of the invention.

FIG. 2 is a front view of the housing, solar panels, temperature sensor, moisture sensor, and the shade in the retracted position.

FIG. 3 is a bottom view of the housing that includes the wind sensor and the retracted shade.

FIG. 4 is a back view of the housing that includes the hanging bracket.

FIG. 5 is a top view of the housing that includes the moisture sensor, hanging bracket, and solar panels.

FIG. 6 is a cross section view of the invention.

FIG. 7 is a view of an end cap.

FIG. 8 is a view of another end cap that includes the access cover to the DIP switches.

FIG. 9 is a diagram of the microcontroller and the devices it reads or controls.

FIG. 10 is a cutaway view of the invention.

### DETAILED DESCRIPTION

The solar-powered window shade, in its preferred embodiment, is comprised of a roller shade mounted in the shade housing. The housing contains the roller shaft and the retracted shade, the reversible DC motor, circuit board and microcontroller, as well as the connections from the solar array, the temperature sensor, the moisture sensor, and the wind sensor to the microcontroller. The exterior of the housing serves as the mounting platform for the solar cell array, the moisture sensor, and the wind sensor. The bottom of the housing has an opening through which the shade extends and retracts. It has optical sensors to determine when the shade is in the specified position. The apparatus is also comprised of two stainless steel guide cables running from the housing on the top and mounted below or to the side of the opening below. The shade ballast has eyes on each side, outside the fabric area, allowing the ballast to serve as the guide to maintain shade proximity to the window when assaulted by high winds.

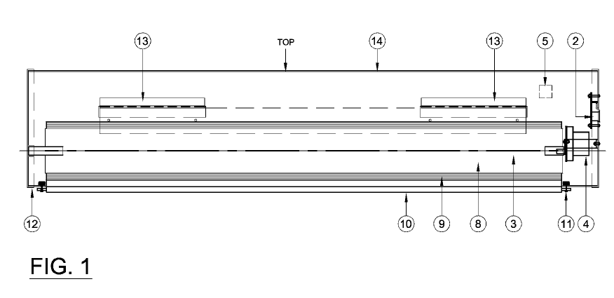

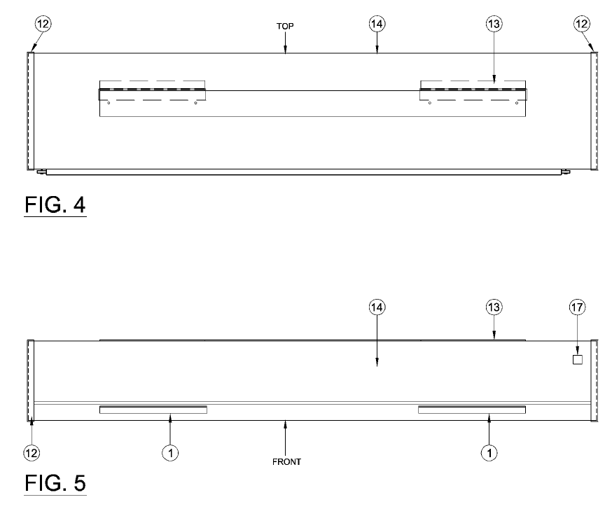

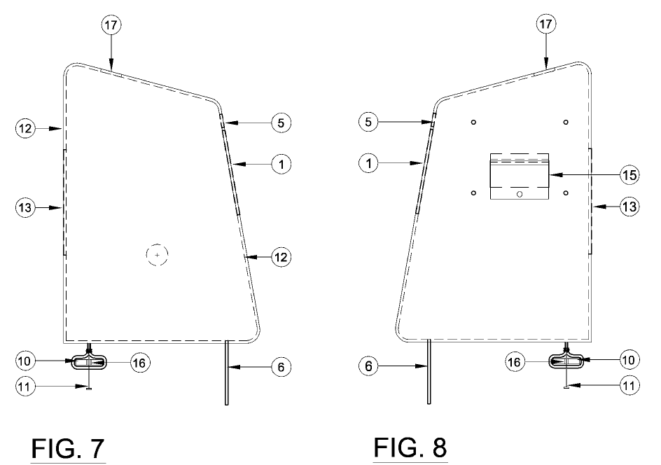

Referring to FIGS. 1, 2, 3, 4, and 5, the housing 14 is comprised of a formed sheet metal, designed to shed water, and end caps 12. The housing is available in multiple widths to match roller shade widths. The back is 8 inches high and the bottom is 3.5 inches deep. The front and top consist of an angled face on which the solar cell array 1 and moisture senor 17 are mounted. The housing is slotted on the back to match the mounting bracket 13. The bracket 13 is mounted above the exterior windows and the housing hangs from the bracket. In FIG. 7, one molded end cap 12 is formed to hold the ends of the shade roller. In FIG. 8, the other end cap is perforated to allow the temperature sensor 5 access to outside air for temperature measurement and serves as the mounting for the circuit board. The end caps are constructed of molded plastic for temperate climates or metal for extreme climates.

To cover most standard windows, the roller shade is available in multiple widths. The roller shade has extension settings for 18, 36, and 54 inch lengths. In FIG. 1, the roller shade consists of the roller shaft 8 and the shade fabric 9, with a shade ballast strip 10 sewn into the bottom of the shade for stability. The shade fabric is waterproof.

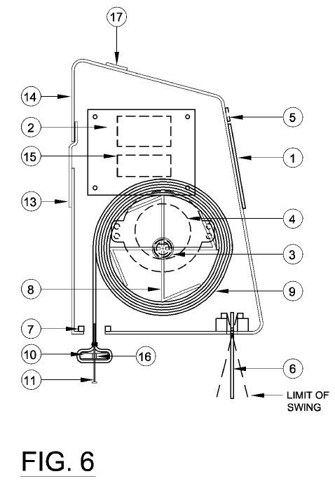

Also in FIG. 1 and FIG. 6, the roller shaft 8 is connected to the slotted shafts 3. The right slotted shaft 3 is connected to the low-voltage reversible DC gear head motor. The motor turns the gear head on the slotted shaft to unroll and thus extend the shade. It also turns it the opposite direction to retract the shade. The direction of travel is a command sent by the microcontroller 2 to the motor. The length of travel is determined by the user and is set using the DIP switches 15. The length-of-travel options are limited to 18 in, 36 in., or 54 in. The motor 4 rotates in the down direction until the down optical sensor 7 reads through the slot in the fabric at the selected length. When the optical sensor is successfully closed, the motor stops the down action.

In FIG. 3, the two stainless steel cables 11 are attached to the outside edges of the housing and passed through the slots 16 in the shade ballast 10. The purpose of the guide cables is to maintain the stability of the shade in the presence of high wind and to ensure smooth rolling when retracting the shade under adverse conditions.

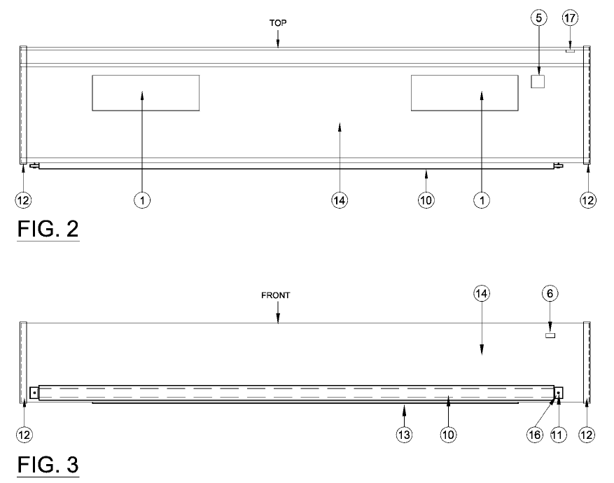

In FIG. 6, the low-voltage reversible DC motor 4 is powered by a solar cell array 1 mounted on the exterior face of the housing (also in FIG. 2 and FIG. 5). The solar cell array 1 powers the motor 4, the temperature sensor 5, the wind sensor 6, the moisture sensor 17, and the optical sensors 7.

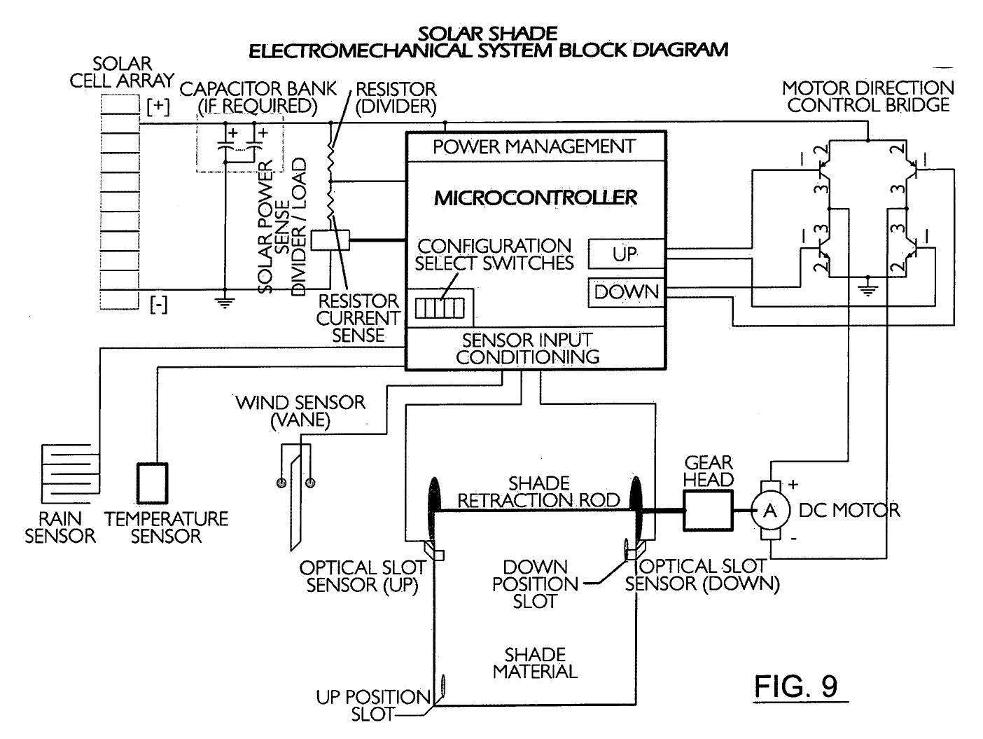

All action is controlled by the microcontroller as seen in FIG. 9. The microcontroller is powered by the solar cell array 1 with the required voltage filtered through the power management system. The power source is backed up by the capacitor bank, which provides sufficient power to retract the shade when sunlight fails. The microcontroller has pre-defined settings for sunlight, based on solar array power level inputs; temperature, based on temperature sensor inputs; moisture, based on moisture sensor inputs; and wind action, based on wind sensor inputs. It also controls the motor's direction of travel based on the sensor data. The environmental sensor data is based on the following, in order of activation: direct sunlight, temperature over 70° F., no moisture present, and low wind action.

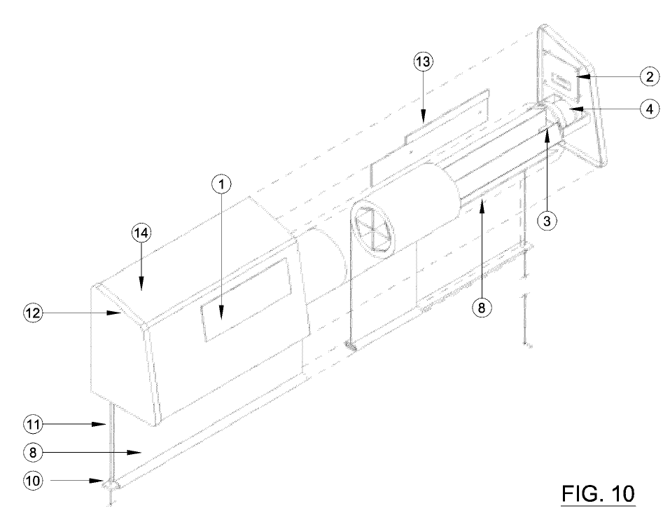

The solar-powered window shade is intended only for windows receiving direct sunlight. If the shade receives only indirect light, then no action occurs. In FIG. 1, FIG. 6, and FIG. 10, when direct sunlight strikes the solar cell array 1, the electrical output of the cells triggers the solar power sense divider/load and activates the microcontroller 2. When the microcontroller is sufficiently powered, the solar array output powers up the temperature sensor 5, the moisture sensor 17, and the wind sensor 6. The microcontroller, as long as it receives the specified level of power from the solar cells, continues to monitor the temperature until it reaches 70° F.

The temperature sensor 5 consists of a silicon integrated circuit precision temperature sensor. The temperature sensor 5 is activated when the solar array achieves the specified level of power. The temperature is monitored until it reaches 70° F. At 70°, the microcontroller 2 sensor input conditioning 2 evaluates the moisture 17, wind 6, and optical 7 sensors to determine whether or not to lower the shade.

In FIG. 1 and FIG. 6, the moisture sensor 17 is an electronic sensor that reads collected surface moisture. When sufficient moisture collects on the surface to close the circuit, the moisture level is considered unacceptable. In FIG. 9, the microcontroller 2 interprets the information as either acceptable or unacceptable. If unacceptable, no further action is taken until the moisture conditions change. If acceptable, the microcontroller then evaluates the wind conditions.

In FIG. 1 and FIG. 6, the wind sensor 6 is an active wind vane. In FIG. 6, the wind vane sensor 6 consists of a conductive hanging vane suspended between electrical contacts. When the hanging vane touches one of the electrical contacts, a digital signal is sent to the microcontroller. When the contact becomes continuous, the microcontroller interprets the information as excessive wind. If the vane in not touching a contact, the microcontroller interprets the information as favorable wind conditions and the final of the four environmental criteria is met.

In FIG. 6, the motor is activated in the down direction until the down optical sensor 7, determines it has reached full extension by the successful closing of the optical circuit. The optical sensors 7 consist of optical emitter/detector pairs that read through slots in the fabric of the shade. The variable extension lengths are executed based on DIP switches 15 for 18, 36, or 54 inches. The down optical sensor 7 reads through the slot in the fabric at the selected length. When the optical sensor is successfully closed, the motor stops the down action.

When there is direct sunlight (solar array 1), the temperature is 70° F. or higher (temperature sensor 5), the moisture sensor 17 indicates acceptable levels, and the wind sensor 6 is not activated, the microcontroller 2 sets the motor 4 rotating in the down direction until the down optical senor 7 indicates the shade has achieved the specified extended length. The shade remains in the down position until the one of the environmental criteria fails.

The most common event that would trigger a criteria failure is diminished sunlight due to overcast skies or sunset. With the failure of the direct sunlight criteria, the microcontroller activates the motor to rotate the roller shade shaft in the up direction until the up optical sensor 7 detects the complete retraction of the shade by the successful closing of the optical circuit through the up position slot.

Other events may include, for example, weather conditions where there is direct sunlight and the temperature remains over 70° F., but the wind begins to blow sufficient to activate the wind sensor or it begins to rain. When the wind sensor 6 or the moisture sensor 17 is triggered, the microcontroller 2 activates the motor 4 to rotate in the up direction until the optical sensor 7 detects the raised position of the shade by the successful closing of the optical circuit through the up position slot.

To avoid a constant up and down motion of the shade due to diminished sunlight caused by moving clouds or the wind speed criteria fails due to gusting winds, the shade is retracted at the first failure and the microcontroller 2 does not attempt to change states for 10 minutes.

What is claimed is:

1. An automatic solar-powered motorized exterior window shade device comprising:
a. a fabric shade with a ballast on a rotating roller shaft that is moveable between the extended and retracted position,
b. a housing for all parts, including the retracted shade,
c. a solar collection array,
d. a reversible DC motor,
e. a collection of environmental sensors,
f. a control device coupled to the said solar array and the said environmental sensors that powers the said motor to move the roller to the extended and retracted positions,
g. and stainless 5 steel cable guide lines to slide the said ballast up and down as a method for stabilizing the shade as it moves in high wind.

2. An automatic solar-powered motorized exterior window shade device as in claim 1 wherein the control device comprises:
h. a microcontroller comprised of a circuit board and firmware that manages power for the said solar collection array and manages and evaluates the input from the said environmental sensors,
i. a motor direction control that directs the motor direction control bridge as to the extension and retraction direction of the motor.

3. An automatic solar-powered motorized exterior window shade device as in claim 2 wherein the solar collection array functionality comprises:
j. a power supply for the said microcontroller,
k. a power supply for the said environmental sensors,
l. a power supply for the said motor.

4. An automatic solar-powered motorized exterior window shade device as in claim 3 wherein the environmental sensors comprise:
m. a solar collection array receiving sufficient sunlight to power up,
n. a temperature sensor,
o. a moisture sensor,
p. a wind sensor.

5. An automatic solar-powered motorized exterior window shade device as in claim 4 wherein the said microcontroller and said environmental sensors interact in the methods comprising:
q. a set power level generated by the said solar collection array that, in accordance with the microcontroller programming, constitutes a positive indication of direct sunlight,
r. a temperature sensor that does not begin taking readings until the said microcontroller programming determines the said set power level is reached, and then the microcontroller reads a positive indication of the set temperature level at 70° F.,
s. a moisture sensor that does not begin taking readings until the set power level is reached, the set temperature level is reached, and then the microcontroller determines if the moisture level is acceptable,
t. a wind sensor that does not begin taking readings until the set power level is reached, the set temperature is reached, the set moisture level is acceptable, and then the microcontroller reads a positive indication based on open circuit, and then,
u. when the microcontroller reads positive on all indicators, it commands the action of the motor to move in the extension direction until stopped by the optical sensors indicating full extension, but
v. when the microcontroller reads negative on any of the indicators and the shade is in the retracted position, no action is taken or, if the shade is in the extended position, the microcontroller commands the action of the motor to move in the retraction direction until the optical sensors indicate complete retraction.

6. An automatic solar-powered motorized exterior window shade device as in claim 5 further comprising extended and retracted optical sensors that are read by the microcontroller where the retraction status input is from the left-hand sensor and the extension status is from the right-hand sensor, in which case a positive reading from the optical sensor to the microcontroller consists of a completed optical circuit.

7. An automatic solar-powered motorized exterior window shade device as in claim 5 further comprising an electronic moisture sensor that collects moisture on the surface and sends signals to the microcontroller when the sensor detects moisture.

8. An automatic solar-powered motorized exterior window shade device as in claim 5 further comprising a wind gauge that has a hanging vane suspended between two electrical contacts and sends digital signals to the microcontroller when the vane and a contact connect.

9. An automatic solar-powered motorized exterior window shade device as in claim 1 further comprising a ballast sewn into the lower end of the shade fabric that acts as a weight for the fabric and contains eyes at each end that serve as guides to stabilize the shade during retraction or high wind.

10. An automatic solar-powered motorized exterior window shade device as in claim 1 further comprising of two steel cables affixed to each side of the bottom of the said housing, running through eyes on the said ballast, and then affixed in appropriate locations to an area below or to the side of the window or opening.

11. An automatic solar-powered motorized exterior window shade device as in claim 1 further comprising shaped metal and two molded end caps that contains the said retracted shade, roller shaft, slotted shafts, motor, microcontroller, temperature sensor, moisture sensor, and wind sensor, and is furthermore, slotted on the back to receive a bracket and to which the said guide lines are affixed.

12. An automatic solar-powered motorized exterior window shade device as in claim 10 further comprising a mounting device that is comprised of a piece of metal 24 inches long and flanged in two locations to match the slots on the back of the shade housing and drilled with 4 holes for mounting to exterior finishes.
